(19) United States
(12) Patent Application Publication
(10) Pub. No.: US 2015/0046025 A1
(43) Pub. Date: Feb. 12, 2015

(54) Fuel Tank Venting System for a Motor Vehicle

(71) Applicant: Daimler AG, Stuttgart (DE)

(72) Inventors: Udo Brinkaemper, Waiblingen (DE); Jens Gruener, Ostfildern (DE); Ramakrishnan Rajagopal, Sindelfingen (DE)

(73) Assignee: Daimler AG, Stuttgart (DE)

(21) Appl. No.: 14/374,482

(22) PCT Filed: Jan. 18, 2013
(86) PCT No.: PCT/EP2013/000144

§ 371 Date: Jul. 24, 2014

(30) Foreign Application Priority Data
Jan. 25, 2012 (DE) 10 2012 001 314.0

(51) Int. Cl. B60K 15/035

(52) U.S. Cl. CPC B60K 15/03519; B60K 2015/0358; B60K 2015/0319
USPC 701/33.4; 137/199

(57) ABSTRACT

A fuel tank venting system for a motor vehicle includes an outlet side of a tank venting valve connected to an inlet side of a first vent line and to an inlet side of a second vent line. An outlet side of the first vent line is connected to an intake manifold upstream from a throttle valve and downstream from an air filter, and an outlet side of the second vent line is connected to the intake manifold downstream from the throttle valve. The first check valve has a first position sensor and the first closing element has a detectable element. The first position sensor is connected to an electronic control device to transmit signals. A position of the first closing element may be determined by means of the position sensor and the detectable element.

### BACKGROUND AND SUMMARY OF THE INVENTION

Exemplary embodiment of the invention relate to a fuel tank venting system for a motor vehicle and a method for diagnosing a fuel tank venting system.

The basic design of conventional fuel tank venting systems for motor vehicles and their function is described, for example, in ATZ Automobiltechnische Zeitschrift 101 (1993) 3, pages 166-173.

German patent document DE 10 2009 008 831 A1 discloses a fuel tank venting system of the generic kind Upstream from a throttle valve, a first vent line is connected to an intake manifold of a motor vehicle via a first check valve. Downstream from the throttle valve, a second vent line is connected to the intake manifold via a second check valve. In this system, it is possible to detect leaks in the first or second vent line up to the position of the first check valve, using an intake manifold pressure sensor which is already present in the intake manifold. In this system configuration, a leak between the first check valve and the intake manifold cannot be detected. However, since the regulatory requirements in the United States stipulate that all types of leaks or blockages must be detectable unless components are connected via nondetachable connections, German patent document DE 10 2009 008 831 A1 proposes connecting the first check valve to the intake manifold via a nondetachable connection. For this purpose, the first check valve is positioned very closely to the intake manifold, at the end of the first vent line. This system has a drawback with regard to repair shop user-friendliness, since removal or replacement of the intake manifold can take place only together with the first check valve.

In addition, PCT publication WO 2009/106221 A1 discloses a check valve having a distance sensor, in which a movable part of the distance sensor is connected to a closing element of the check valve. The movable part may be a permanent magnet. A position of the permanent magnet, and thus of the closing element, may be measured using a Hall sensor. It is proposed to thus measure a volume flow of a fluid flowing through the check valve.

Exemplary embodiments of the present invention are directed to improving the repair shop user-friendliness of the generic fuel tank venting system while ensuring continued diagnostic capability in compliance with regulatory requirements.

The fuel tank venting system has an intake manifold for supplying air to a cylinder of an internal combustion engine of the motor vehicle, the intake manifold including a throttle valve and, upstream from the throttle valve, an air filter. In addition, the fuel tank venting system has a fuel tank, a tank vent valve, a cutoff valve, and an electronic control device, the electronic control device being connected to the throttle valve, the tank vent valve, and the cutoff valve, in each case for the purpose of controlled actuation. The control device may be a control unit or an assembly of multiple control units that are interconnected via communication connections. The connection between the electronic control device and the throttle valve, the tank vent valve, and the cutoff valve may be wired or wireless. Furthermore, the fuel tank venting system has a first vent line that includes a first check valve having a first closing element, and a second vent line, the cutoff valve being indirectly or directly connected to an inlet side of the tank vent valve, and an outlet side of the tank vent valve being connected to an inlet side of the first vent line and to an inlet side of the second vent line. The closing element of the check valve may be designed as a sphere, cone, flap, or diaphragm, or as some other known closing element.

An outlet side of the first vent line is connected to the intake manifold upstream from the throttle valve and downstream from the air filter, and an outlet side of the second vent line is connected to the intake manifold downstream from the throttle valve. The terms “upstream” and “downstream” refer to a direction of an air flow in the intake manifold.

According to the invention, the first check valve has a first position sensor for determining a position of a detectable element of the first closing element, the first position sensor being connected to the electronic control device for the purpose of signal transmission. Here as well, the mentioned connection may be implemented in a wired or wireless manner.

In the mentioned system configuration, by means of the first position sensor and the detectable element of the first check valve it is possible to detect leaks or obstructions in the first vent line. The leaks or obstructions may be detected over the entire distance between the tank vent valve, over the first vent line up to the intake manifold, i.e., up to the air filter.

A first advantageous refinement of the invention provides that the detectable element includes a magnet element, and the first position sensor includes a Hall sensor. A magnet element may be mounted on or in the closing element in a cost-effective manner. A position of the magnet element, and thus of the first closing element, may be determined by means of the Hall sensor. In this case, the Hall sensor may be mounted in a flow channel of the check valve, or particularly advantageously, also outside the flow channel. A mounting outside the flow channel is cost-effective and robust.

The closing element is particularly advantageously designed in such a way that its position changes only in one direction during opening and closing, i.e., primarily in such a way that the closing element cannot rotate during opening and closing. This type of design is provided, for example, as a flap that is fastened on one side, or a diaphragm that is fastened on one side. Another advantageous refinement therefore provides that the first closing element includes a non-return flap. The non-return flap particularly advantageously has a leaf spring, the leaf spring exerting a force on the non-return flap in the direction of a closed position of the non-return flap. The check valve may thus be installed in the motor vehicle independently of position, since closing of the closing element occurs primarily due to an elastic force of the leaf spring, not due to gravity.

Another advantageous refinement provides that the second vent line includes a second check valve having a second closing element. In this case, a leak in the second vent line may advantageously be detected by means of an intake manifold pressure sensor situated in the intake manifold, downstream from the throttle valve.

Another advantageous refinement provides that the first check valve and the second check valve are situated in a shared housing and form a double check valve, an inlet side of the double check valve at the same time forming the inlet side of the first vent line and the inlet side of the second vent line. Costs and space requirements may thus be reduced in the fuel tank venting system according to the invention.

Another advantageous refinement of the invention provides that a crankcase vent line is connected to the first vent line. This has the advantage that not only leaks in the first vent line, but also leaks in the crankcase vent line may be detected by means of the first position sensor.

Another advantageous refinement of the invention provides that the intake manifold has a turbocharger upstream from the throttle valve. When the fuel tank venting system contains the turbocharger upstream from the throttle valve, there is no negative pressure in the intake manifold downstream from the throttle valve during full load operation of the internal combustion engine, and instead, there is a negative pressure upstream from the turbocharger. In this configuration, the first vent line opens into the intake manifold upstream from the turbocharger. Due to the negative pressure generated by the turbocharger under full load, leak detection may be carried out particularly easily by the first position sensor.

The method for diagnosing a fuel tank venting system of a motor vehicle is characterized by a fuel tank venting system according to the invention, whereby

a piece of error information is stored in the electronic control device, when a closed position of the first closing element is determined by means of the first position sensor, and

a full load regeneration operation is present,

and a piece of error information is stored in the electronic control device when an open position of the first closing element (12) is determined by means of the first position sensor

and no full load regeneration operation is present.

The presence of a full load regeneration operation or a partial load regeneration operation is a function of a load on the internal combustion engine and a switching position of the tank vent valve, whereby the load on the internal combustion engine may be derived from measurement variables and/or control variables, for example a throttle valve position. A full load regeneration operation is present when a high load and/or a wide-open throttle valve is/are present, and at the same time the tank vent valve is open. The term “wide open” with regard to the throttle valve means a degree of opening of greater than 50%, particularly advantageously greater than 70%. A partial load regeneration operation is present when a low load and/or a slightly open throttle valve is/are present, and at the same time the tank vent valve is open. The term “slightly open” with regard to the throttle valve means a degree of opening of less than 50%. The method is carried out according to the invention by means of the electronic control device, which is connected to all relevant electrical and electronic components and which has means for data processing.

A first refinement of the method for diagnosing provides that the intake manifold of the fuel tank venting system has a turbocharger, it being determined as a function of a rotational speed of the turbocharger whether a full load regeneration operation or a partial load regeneration operation is present.

A second refinement of the method for diagnosing provides that the second vent line includes a second check valve having a second closing element, the second check valve having a second position sensor for determining a position of a second detectable element of the second closing element, the second position sensor being connected to the electronic control device, wherein

when a closed position of the second closing element is determined by means of the second position sensor and a partial load regeneration operation is present, a piece of error information is stored in the electronic control device,

and when an open position of the second closing element is determined by means of the second position sensor and no partial load regeneration operation is present, a piece of error information is stored in the electronic control device.

A leak and an obstruction of the second vent line may be reliably detected with the aid of the second position sensor and the second detectable element.

### BRIEF DESCRIPTION OF THE DRAWING FIGURES

The invention is described below with reference to exemplary embodiments and associated drawings from which further features and advantages of the invention result. Identical elements are provided with the same reference numerals in the drawings.

The figures show the following:

FIG. 1 shows a schematic illustration of a fuel tank venting system,

FIG. 2 shows a design representation of a double check valve together with a position sensor, and

FIG. 3 shows a flow diagram for a method for diagnosing a fuel tank venting system.

### DETAILED DESCRIPTION

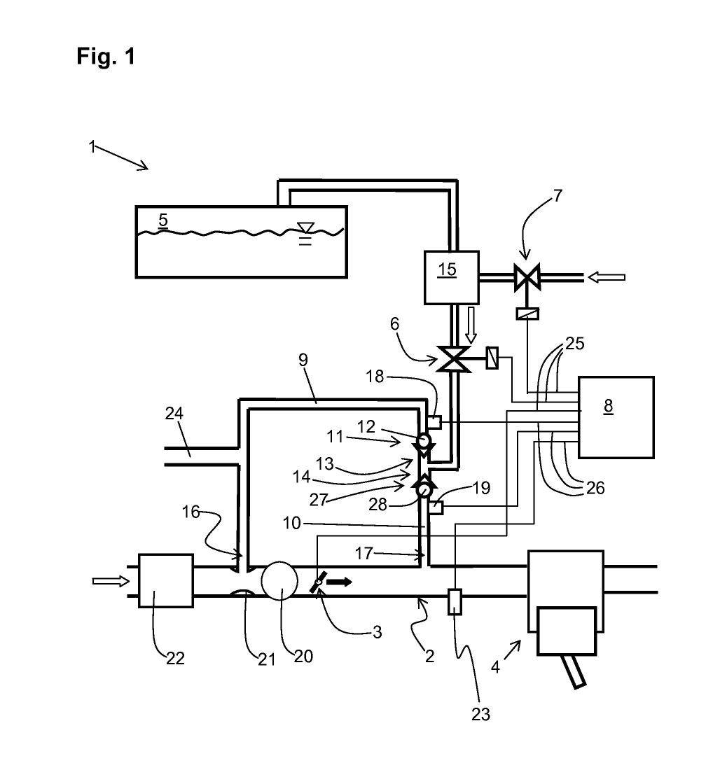

FIG. 1 shows a schematic illustration of a fuel tank venting system 1 of a motor vehicle, not illustrated in greater detail. The fuel tank venting system 1 includes an intake manifold 2 having a throttle valve 3, an intake manifold pressure sensor 23 of a Venturi throat 21, a turbocharger 20, and an air filter 22. The intake manifold 2 is connected to a cylinder 4 of an internal combustion engine, not illustrated in greater detail. The fuel tank venting system 1 also has a fuel tank 5, which at its top side is connected to an activated carbon container 15. The connection may include further components, such as a valve. The activated carbon container 15 is connected to the atmosphere via a cutoff valve 7, and is connected to an inlet side 13 of a first vent line 9 and to an inlet side 14 of a second vent line 10 via a tank vent valve 6. An outlet side 16 of the first vent line 9 is connected to the intake manifold 2 at the Venturi throat 21, upstream from the turbocharger 20. An outlet side 17 of the second vent line 10 is connected to the intake manifold 2 downstream from the throttle valve 3. In the area of its inlet side 13, the first vent line 9 contains a first check valve 11 having a first closing element 12, the first check valve 11 opening in the direction of the outlet side 16. In the area of its inlet side 14, the second vent line 10 contains a second check valve 27 having a second closing element 28, the second check valve 27 opening in the direction of the outlet side 17. The first check valve 11 and the second check valve 12 are advantageously integrated into a shared housing for a double check valve. The first check valve 11 also has a first position sensor 18, and the second check valve 27 has a second position sensor 19. The first position sensor 18 is necessary for a diagnostic method for detecting leaks or obstructions of the first vent line 9, and the second position sensor 19 is necessary for detecting leaks or obstructions of the second vent line 10. Alternatively, the second position sensor 19 may be dispensed with if the second vent line 10 is diagnosed by means of the intake manifold pressure sensor 23.

The first vent line is connected to a crankcase vent line 24 in the area between the first check valve and the outlet side 16, the fuel tank venting system 1 according to the invention also including an alternative junction of the crankcase vent line 24 directly into the intake manifold 2; in the latter case the crankcase vent line 24 opens into the intake manifold 2 between the turbocharger 20 and the air filter 22.

The fuel tank venting system also has an electronic control device 8 which is an engine control unit, a tank control unit, or an assembly of control units, for example. The electronic control device 8 is connected to the electronically controllable tank vent valve, the electronically controllable cutoff valve 7, and the electronically actuatable throttle valve via control lines 25. Alternatively, the throttle valve 3, the tank vent valve 6, and the cutoff valve 7 may be pneumatically or hydraulically actuatable, in which case hydraulic or pneumatic actuators would be controlled by the electronic control device.

The electronic control device 8 is also connected to the intake manifold pressure sensor 23, the first position sensor 18, and the second position sensor 19 via signal lines 26. The electronic control device 8 is also connected (not illustrated in FIG. 1) to a position sensor of the throttle valve 3 via a signal line.

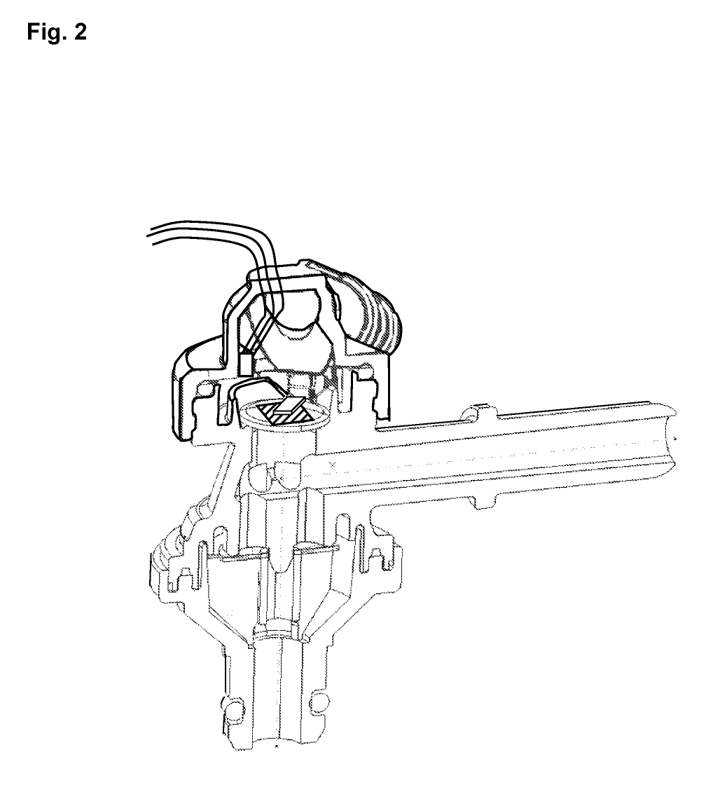

FIG. 2 shows a design representation of a double check valve 129, which includes the first check valve 111 and the second check valve 127. The first check valve 111 includes the first position sensor 118 in the form of a Hall sensor. A position of a first detectable element 130, which in the present case is in the form of a permanent magnet, may be determined by means of the first position sensor 118. The first detectable element 130 is situated on the first closing element 112, the first closing element 112 being a non-return flap. Likewise situated above the first closing element 112 is a spring element 131 which is used to hold the first closing element 112 in a closed position until there is no pressure drop in the direction of the outlet side 16 of the first vent line 9. The double check valve 129 has a connecting point 132 which is connected to the tank vent valve 6. An area around the first check valve 111 forms the inlet side 113 of the first vent line 9, and an area around the second check valve 127 forms the inlet side 114 of the second vent line 10.

Leaks and obstructions in the first vent line 9 may be detected by means of the first position sensor 118 of the double check valve 129. For the case that the intake manifold 2 has an intake manifold pressure sensor 23, the double check valve 129 advantageously has no second position sensor at the second check valve 127, since in this case leaks and obstructions in the second vent line 10 may be detected by means of the intake manifold pressure sensor 23.

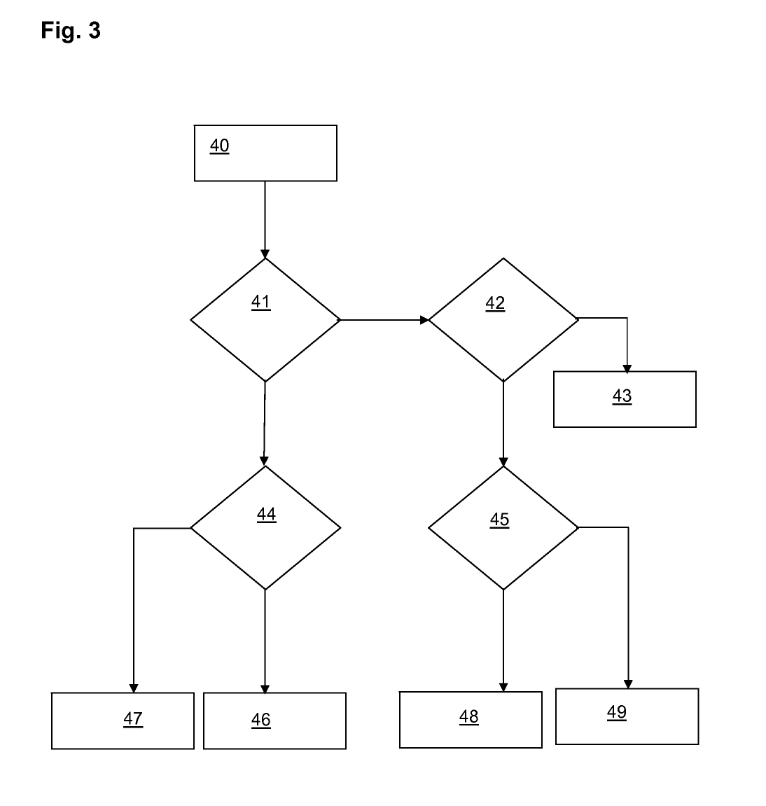

FIG. 3 shows a flow diagram for a method for diagnosing a fuel tank venting system 1.

The diagnostic method begins with a starting step 40 in which a check is made as to whether suitable operating conditions of the internal combustion engine are present for the method. If these conditions are present, a first check step 41 follows in which a check is made as to whether a full load regeneration operation of the tank venting system 1 is present. If a full load regeneration operation is present, a third check step 44 follows in which a check is made by means of the first position sensor 18, 118 as to whether the first closing element 12, 112 is in an open position. If the first closing element 12, 112 is in an open position, the method is terminated with a first result step 46, a piece of information concerning the absence of an error in the first vent line being stored. If the first closing element 12, 112 is in a closed position, the method is terminated with a second result step 47, a piece of information concerning the presence of an error in the first vent line being stored, since in this method step the closed first closing element 12, 112 indicates that a pressure drop over the first check valve 11, 111, which would indicate a leak or an obstruction of the first vent line 9, is not present.

If it is established in the first check step 41 that a full load regeneration operation is not present, either a termination step 43 follows, namely, when the second vent line is not to be monitored using this method, or a second check step 42 is carried out in which a check is made as to whether a partial load regeneration operation is present. If no partial load regeneration operation is present, the termination step 43 is carried out; otherwise, a fourth check step 45 is made in which a check is made by means of the second position sensor 19 as to whether the second closing element 28 is in an open position. If the second closing element 28 is in an open position, the method is terminated with a third result step 48, a piece of information concerning the absence of an error in the second vent line being stored. If the second closing element 28 is in a closed position, the method is terminated with a fourth result step 49, a piece of information concerning the presence of an error in the second vent line 10 being stored, since in this method step the closed second closing element 28 indicates that a pressure drop over the second check valve 27, which would indicate a leak or an obstruction of the second vent line 10, is not present.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 Fuel tank venting system
2 Exhaust manifold
3 Throttle valve
4 Cylinder
5 Fuel tank
6 Tank vent valve
7 Cutoff valve
8 Electronic control device
9 First vent line
10 Second vent line
11, 111 First check valve
12, 112 First closing element
13, 113 Inlet side of the first vent line
14, 114 Inlet side of the second vent line
15 Activated carbon container
16 Outlet side of the first vent line
17 Outlet side of the second vent line
18, 118 First position sensor
19 Second position sensor
20 Turbocharger
21 Venturi throat
22 Air filter
23 Exhaust manifold pressure sensor
24 Crankcase vent line
25 Control lines
26 Signal lines
27, 127 Second check valve
28 Second closing element
129 Double check valve
130 First detectable element
131 Spring element
132 Connecting point
40 Starting step
41 First check step
42 Second check step
43 Termination step
44 Third check step
45 Fourth check step
46 First result step
47 Second result step
48 Third result step
49 Fourth result step

1-10. (canceled)

11. A fuel tank venting system for a motor vehicle, comprising:
an intake manifold configured to supply air to a cylinder of an internal combustion engine of the motor vehicle, the intake manifold including a throttle valve and an air filter;
a fuel tank;
a tank vent valve;
a cutoff valve;
an electronic control device configured to actuate the throttle valve, the tank vent valve, and the cutoff valve;
a first vent line, which includes a first check valve having a first closing element, and
a second vent line,
wherein the cutoff valve is indirectly or directly connected to an inlet side of the tank vent valve, and an outlet side of the tank vent valve is connected to an inlet side of the first vent line and to an inlet side of the second vent line,
wherein an outlet side of the first vent line is connected to the intake manifold upstream from the throttle valve and downstream from the air filter, and an outlet side of the second vent line is connected to the intake manifold downstream from the throttle valve,
wherein the first check valve has a first position sensor, and the first closing element has a detectable element, the first position sensor is connected to the electronic control device to transmit a signal, and
wherein a position of the first closing element is determinable by the position sensor and the detectable element.

12. The fuel tank venting system of claim 11, wherein the first position sensor includes a Hall sensor, and the detectable element is a magnet element.

13. The fuel tank venting system of claim 11, wherein the first closing element includes a non-return flap having a spring element, the spring element configured to exert a force on the non-return flap in a direction of a closed position of the non-return flap.

14. The fuel tank venting system of claim 11, wherein the second vent line includes a second check valve having a second closing element.

15. The fuel tank venting system of claim 14, wherein the first check valve and the second check valve are situated in a shared housing in a form of a double check valve, an inlet side of the double check valve forming both the inlet side of the first vent line and the inlet side of the second vent line.

16. The fuel tank venting system of claim 11, wherein a crankcase vent line is indirectly or directly connected to the first vent line.

17. The fuel tank venting system of claim 11, wherein the intake manifold has a turbocharger upstream from the throttle valve and downstream from a junction of the first vent line.

18. A method for diagnosing a fuel tank venting system, wherein the fuel tank venting system includes an intake manifold configured to supply air to a cylinder of an internal combustion engine of the motor vehicle, the intake manifold including a throttle valve and an air filter; a fuel tank; a tank vent valve; a cutoff valve; an electronic control device configured to actuate the throttle valve, the tank vent valve, and the cutoff valve; a first vent line, which includes a first check valve having a first closing element, and a second vent line, wherein the cutoff valve is indirectly or directly connected to an inlet side of the tank vent valve, and an outlet side of the tank vent valve is connected to an inlet side of the first vent line and to an inlet side of the second vent line, wherein an outlet side of the first vent line is connected to the intake manifold upstream from the throttle valve and downstream from the air filter, and an outlet side of the second vent line is connected to the intake manifold downstream from the throttle valve, the method comprising:
performing a regeneration operation by simultaneously opening the tank vent valve and the cutoff valve;
determining, during the regeneration operation, whether a full load regeneration operation or a partial load regeneration operation is present as a function of a degree of opening of the throttle valve,
wherein the first check valve has a first position sensor for determining a position of a first detectable element of the first closing element, the first position sensor being connected to the electronic control device for the purpose of signal transmission,
wherein a piece of error information is stored in the electronic control device when a closed position of the first closing element is determined by means of the first position sensor and a full load regeneration operation is present, and
wherein a piece of error information is stored in the electronic control device when an open position of the first closing element is determined by means of the first position sensor and no full load regeneration operation is present.

19. The method of claim 18, wherein the intake manifold of the fuel tank venting system has a turbocharger, a rotational speed of the turbocharger is used to determine whether a full load regeneration operation or a partial load regeneration operation is present.

20. The method of claim 18, wherein
the second vent line includes a second check valve having a second closing element,
the second check valve includes a second position sensor for determining a position of a second detectable element of the second closing element, the second position sensor being connected to the electronic control device,
a piece of error information is stored in the electronic control device when a closed position of the second closing element is determined by means of the second position sensor and a partial load regeneration operation is present, and
a piece of error information is stored in the electronic control device when an open position of the second closing element is determined by means of the second position sensor and no partial load regeneration operation is present.
